(19) United States
(12) Patent Application Publication
(10) Pub. No.: US 2014/0056705 A1
(43) Pub. Date: Feb. 27, 2014

(54) LOAD CONTROL SYSTEM AND METHOD FOR WIND TURBINE

(71) Applicants: Danian Zheng, Simpsonville, SC (US); Hua Xia, Altamont, NY (US); Kevin Thomas McCarthy, Troy, NY (US); Dale Robert Mashtare, Simpsonville, SC (US)

(72) Inventors: Danian Zheng, Simpsonville, SC (US); Hua Xia, Altamont, NY (US); Kevin Thomas McCarthy, Troy, NY (US); Dale Robert Mashtare, Simpsonville, SC (US)

(73) Assignee: GENERAL ELECTRIC COMPANY, Schenectady, NY (US)

(21) Appl. No.: 13/590,430

(22) Filed: Aug. 21, 2012

(51) Int. Cl. F03D 7/00; F03D 11/00

(52) U.S. Cl. 416/1; 416/61

(57) ABSTRACT

A load control system for a wind turbine and a method for controlling wind turbine loading are provided. The system includes a sensor assembly. The sensor assembly includes a light source mounted to a rotor shaft and configured to emit a light, and a sensor mounted to the rotor shaft and configured to sense the light and measure a location of the light in a plane perpendicular to a longitudinal axis. The system further includes a controller communicatively coupled to the sensor assembly.

### FIELD OF THE INVENTION

The present disclosure relates generally to wind turbines, and more particularly to load control systems in wind turbines and methods for controlling wind turbine loading.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and a rotor including one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

During operation of a wind turbine, various components of the wind turbine are subjected to various loads due to the aerodynamic wind loads acting on the blade. In particular, the shaft coupling the rotor blades and the generator may be subjected to various loads due to the wind loading acting on the rotor blades and resulting reaction loads being transmitted to the shaft. Such loading may include, for example, axial loads and moment loads, such as bending moment loads and torsional (twisting) moment loads. Deflection of the shaft due to these loads may thus frequently occur during operation of the wind turbine. When the loads are significantly high, substantial damage may occur to the rotor shaft, pillow blocks, bedplate and/or various other component of the wind turbine. Thus, the moment loads induced on the shaft due to such loading are particularly critical variable, and in many cases should desirably be controlled during operation of the wind turbine.

However, currently known systems and methods for controlling such loads, may not be accurate and/or may be poorly located. For example, proximity probes may be mounted to a flange on the shaft to monitor displacement. However, such probes must be mounted in relatively stable locations, which are typically in small, inaccessible areas, thus making it difficult to install and maintain the probes. Further, such probes require expensive, durable mounting hardware. Still further, the data provided by these probes provides only indirect measurements of the loads to which the shaft is subjected. These various disadvantages can result in inaccuracy and poor reliability.

Thus, an improved system and method for controlling loads in a wind turbine is desired. For example, a system and method that provide more accurate and reliable measurements of shaft loading would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a load control system for a wind turbine. The wind turbine includes a rotor shaft defining a longitudinal axis. The load control system includes a sensor assembly. The sensor assembly includes a light source mounted to the rotor shaft and configured to emit a light, and a sensor mounted to the rotor shaft and configured to sense the light and measure a location of the light in a plane perpendicular to the longitudinal axis. The load control system further includes a controller communicatively coupled to the sensor assembly.

In another embodiment, the present disclosure is directed to a method for controlling wind turbine loading. The method includes emitting a light from a light source mounted to a rotor shaft, sensing the light at a sensor mounted to the rotor shaft, and calculating a rotor shaft moment based on a location on the sensor of the sensed light.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 illustrates a perspective, internal view of a nacelle of a wind turbine according to one embodiment of the present disclosure;

FIG. 3 illustrates a cross-sectional view of a shaft of a wind turbine according to one embodiment of the present disclosure;

FIG. 4 illustrates a cross-sectional view of a shaft of a wind turbine according to another embodiment of the present disclosure;

FIG. 5 is a front view of a sensor for a sensor assembly according to one embodiment of the present disclosure;

FIG. 6 illustrates graphs representing various data measurements by the sensor of FIG. 5;

FIG. 7 is a front view of a sensor for a sensor assembly according to another embodiment of the present disclosure;

FIG. 8 illustrates graphs representing various data measurements by the sensor of FIG. 7; and,

FIG. 9 is a front view of a sensor for a sensor assembly according to another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

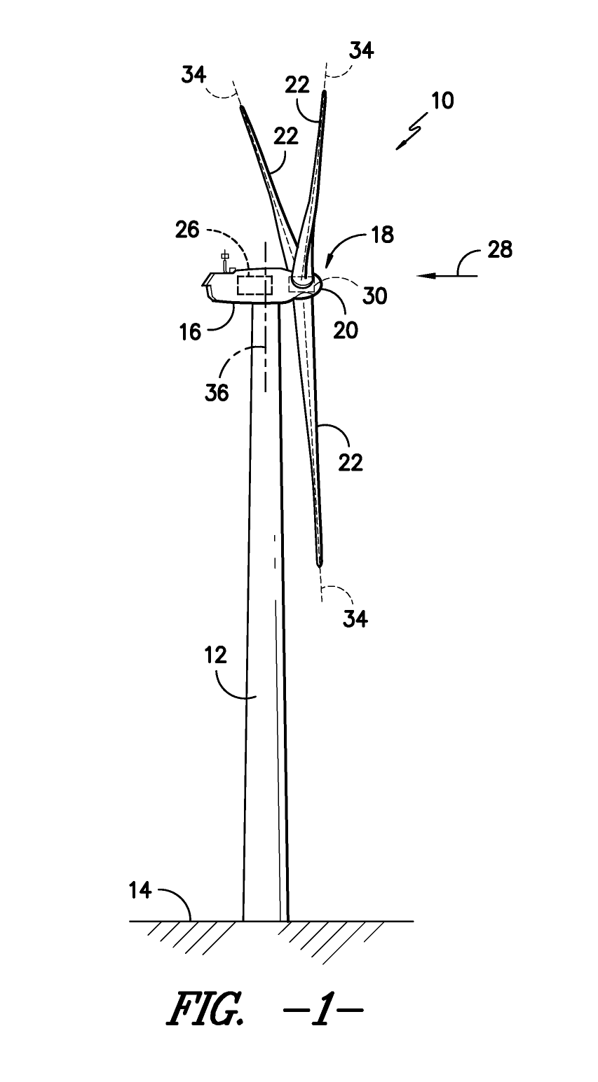

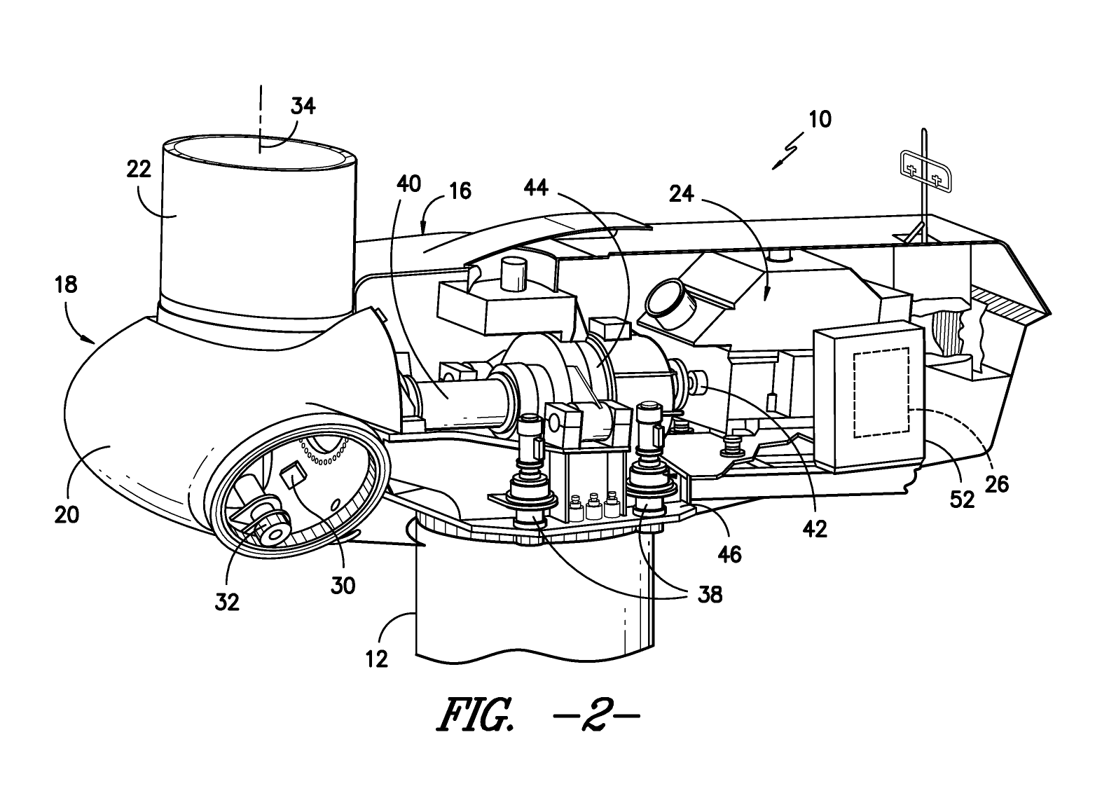

FIG. 1 illustrates perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or a turbine controller 26 centralized within the nacelle 16. However, it should be appreciated that the turbine controller 26 may be disposed at any location on or in the wind turbine 10, at any location on the support surface 14 or generally at any other location. The turbine controller 26 may generally be configured to control the various operating modes (e.g., start-up or shut-down sequences) and/or components of the wind turbine 10. For example, the controller 26 may be configured to control the blade pitch or pitch angle of each of the rotor blades 22 (i.e., an angle that determines a perspective of the rotor blades 22 with respect to the direction 28 of the wind) to control the loading on the rotor blades 22 by adjusting an angular position of at least one rotor blade 22 relative to the wind. For instance, the turbine controller 26 may control the pitch angle of the rotor blades 22, either individually or simultaneously, by transmitting suitable control signals/commands to a pitch controller 30 of the wind turbine 10, which may be configured to control the operation of a plurality of pitch drives or pitch adjustment mechanisms 32 (FIG. 2) of the wind turbine. Specifically, the rotor blades 22 may be rotatably mounted to the hub 20 by one or more pitch bearing(s) (not illustrated) such that the pitch angle may be adjusted by rotating the rotor blades 22 along their pitch axes 34 using the pitch adjustment mechanisms 32. Further, as the direction 28 of the wind changes, the turbine controller 26 may be configured to control a yaw direction of the nacelle 16 about a yaw axis 36 to position the rotor blades 22 with respect to the direction 28 of the wind, thereby controlling the loads acting on the wind turbine 10. For example, the turbine controller 26 may be configured to transmit control signals/commands to a yaw drive mechanism 38 (FIG. 2) of the wind turbine 10 such that the nacelle 16 may be rotated about the yaw axis 30.

It should be appreciated that the turbine controller 26 and/or the pitch controller 30 may generally comprise a computer or any other suitable processing unit. Thus, in several embodiments, the turbine controller 26 and/or pitch controller 30 may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the turbine controller 26 and/or pitch controller 30 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the turbine controller 26 and/or pitch controller 30 to perform various computer-implemented functions. In addition, the turbine controller 26 and/or pitch controller 30 may also include various input/output channels for receiving inputs from sensors and/or other measurement devices and for sending control signals to various components of the wind turbine 10.

Referring now to FIG. 2, a simplified, internal view of one embodiment of the nacelle 16 of the wind turbine 10 is illustrated. As shown, a generator 24 may be disposed within the nacelle 16. In general, the generator 24 may be coupled to the rotor 18 of the wind turbine 10 for generating electrical power from the rotational energy generated by the rotor 18. For example, the rotor 18 may include a main rotor shaft 40 coupled to the hub 20 for rotation therewith. The generator 24 may then be coupled to the rotor shaft 40 such that rotation of the rotor shaft 40 drives the generator 24. For instance, in the illustrated embodiment, the generator 24 includes a generator shaft 42 rotatably coupled to the rotor shaft 40 through a gearbox 44. However, in other embodiments, it should be appreciated that the generator shaft 42 may be rotatably coupled directly to the rotor shaft 40. Alternatively, the generator 24 may be directly rotatably coupled to the rotor shaft 40 (often referred to as a “direct-drive wind turbine”).

It should be appreciated that the rotor shaft 40 may generally be supported within the nacelle by a support frame or bedplate 46 positioned atop the wind turbine tower 12. For example, the rotor shaft 40 may be supported by the bedplate 46 via a pair of pillow blocks 48, 50 mounted to the bedplate 46.

Additionally, as indicated above, the turbine controller 26 may also be located within the nacelle 16 of the wind turbine 10. For example, as shown in the illustrated embodiment, the turbine controller 26 is disposed within a control cabinet 52 mounted to a portion of the nacelle 16. However, in other embodiments, the turbine controller 26 may be disposed at any other suitable location on and/or within the wind turbine 10 or at any suitable location remote to the wind turbine 10. Moreover, as described above, the turbine controller 26 may also be communicatively coupled to various components of the wind turbine 10 for generally controlling the wind turbine and/or such components. For example, the turbine controller 26 may be communicatively coupled to the yaw drive mechanism(s) 38 of the wind turbine 10 for controlling and/or altering the yaw direction of the nacelle 16 relative to the direction 28 (FIG. 1) of the wind. Similarly, the turbine controller 26 may also be communicatively coupled to each pitch adjustment mechanism 32 of the wind turbine 10 (one of which is shown) through the pitch controller 30 for controlling and/or altering the pitch angle of the rotor blades 22 relative to the direction 28 of the wind. For instance, the turbine controller 26 may be configured to transmit a control signal/command to each pitch adjustment mechanism 32 such that one or more actuators (not shown) of the pitch adjustment mechanism 32 may be utilized to rotate the blades 22 relative to the hub 20.

As discussed above, during operation of a wind turbine 10, the wind turbine 10 may be subjected to various loads. In particular, due to the loads to which the wind turbine 10 is subjected, the rotor shaft 40 may be subjected to various loads. Such loads may include axial (or thrust) loads 90 and moment loads, which may include bending moment loads 92 and torsional loads 94. The axial loads 90 may occur generally along a longitudinal axis 98 of the shaft 40, and the bending loads 92 and torsional loads 94 may occur about the longitudinal axis 98.

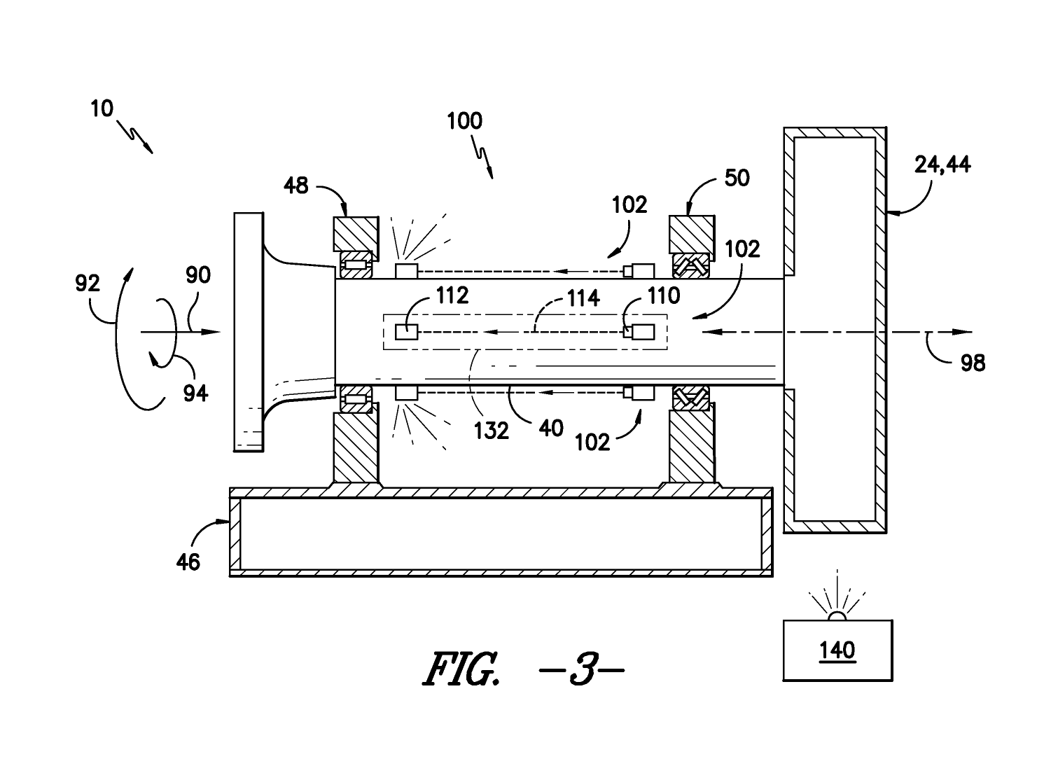

As discussed, improved systems and methods for controlling loads in wind turbines 10, and in particular improved systems and methods for controlling shaft 40 loading, are desired in the art. Thus, FIGS. 3 and 4 illustrate embodiments of a load control system 100 for a wind turbine 10. A load control system 100 may include, for example, one or more sensor assemblies 102. Each sensor assembly 102 may generally be mounted to the shaft 40, and may measure movement of the shaft due to moment loading thereof. One, two, three, four or more sensor assemblies 102 may be included on a shaft 40. In some embodiments, more than one sensor assembly 102 may be arranged in an annular array about the shaft 40. The sensor assemblies 102 may be equally or unequally spaced apart in the annular array.

As shown in FIGS. 3 through 5, 7 and 9, each sensor assembly 102 according to the present disclosure may include a light source 110 and a sensor 112. Both the light source 110 and the sensor 112 of each sensor assembly 102 may be mounted to the shaft 40. For example, the light source 110 and sensor 112 may be mounted through the use of suitable mechanical fasteners, such as nut-bolt combinations, rivets, screws, nails, brackets, etc., or may be welded or otherwise affixed, or may be otherwise suitably connected directly to the shaft 40. In some embodiments, a light source 110 and/or sensor 112 may include a base (not shown) mounted to the shaft, and to which the light source 110 and/or sensor 112 is mounted. Any suitable direct connection of a light source 110 or sensor 112 to a shaft 40, including the use of a base to mount a light source 110 or sensor 112, is within the scope and spirit of the present disclosure.

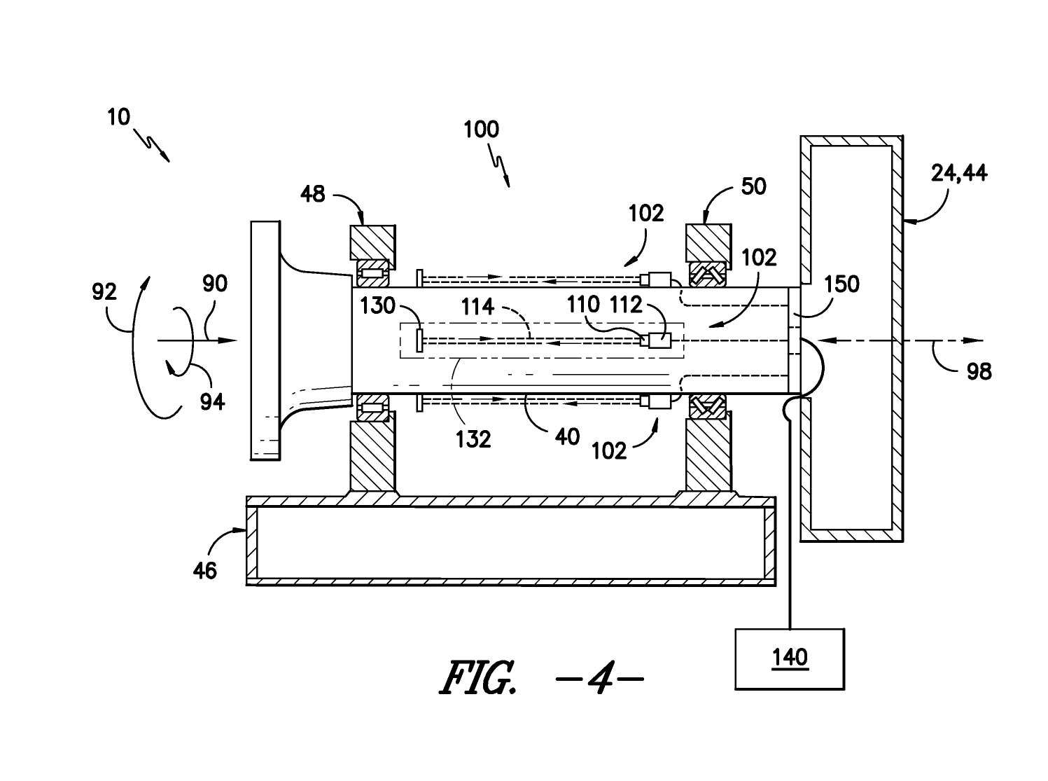

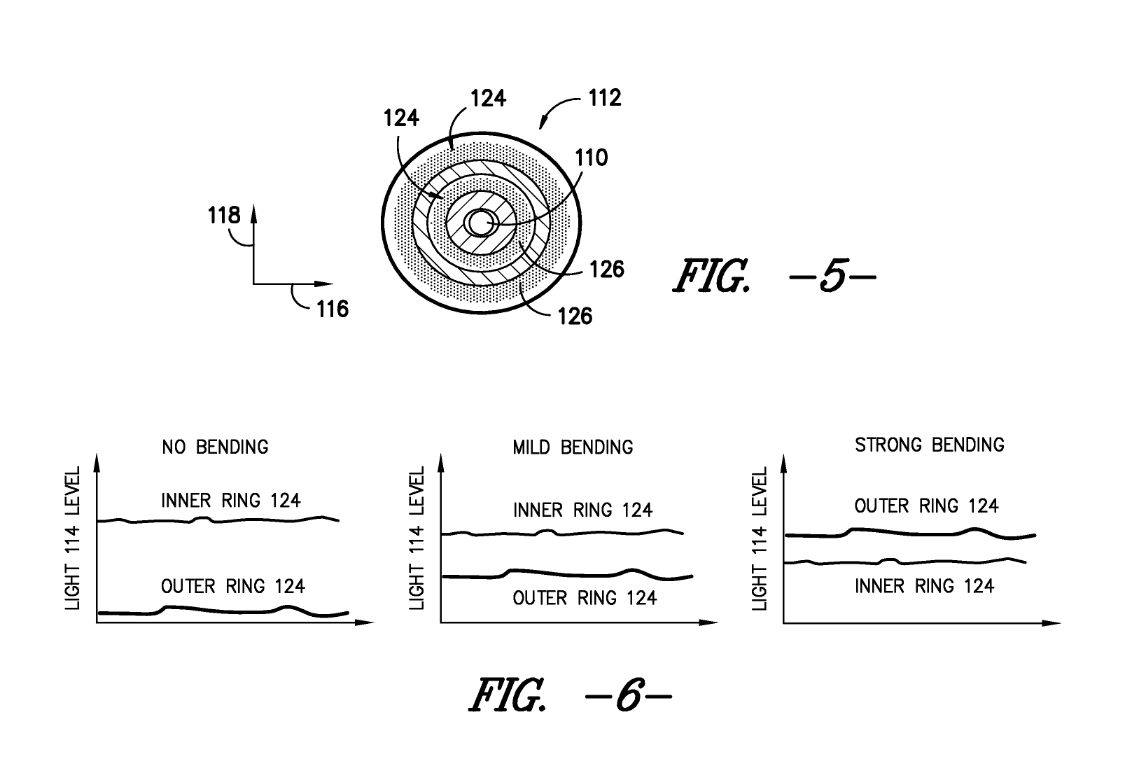

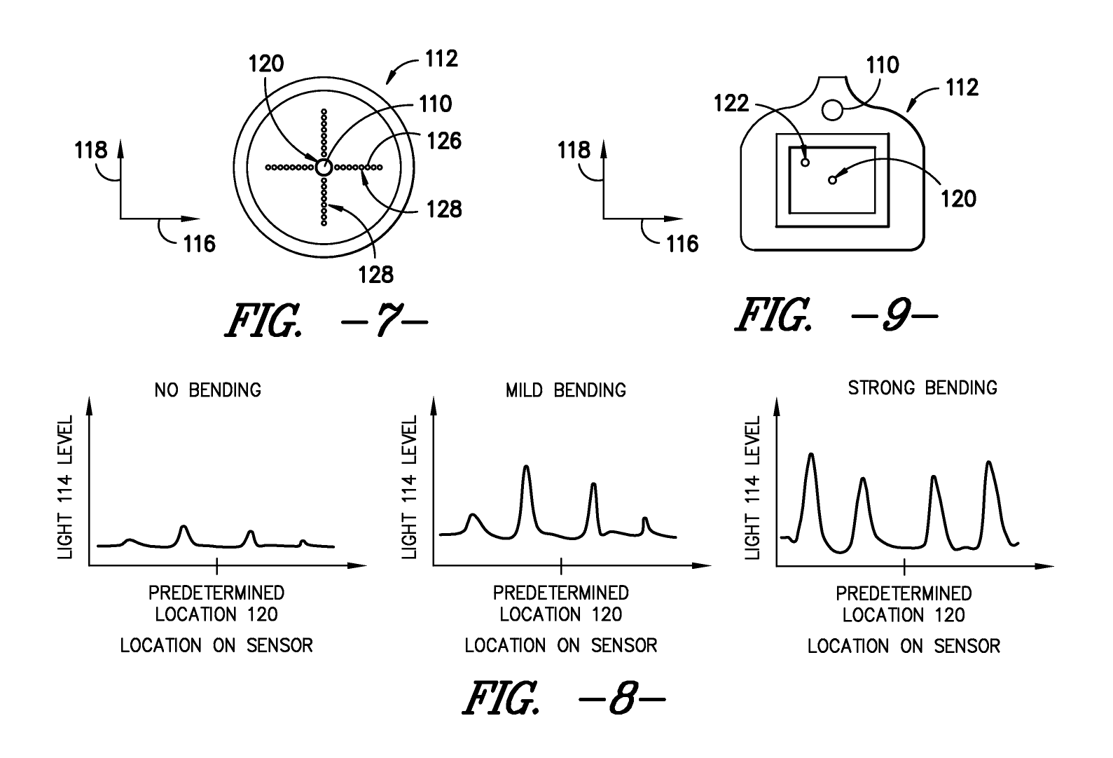

The light source 110 is configured to emit a light 114. In exemplary embodiments, the light 114 is in the visible light spectrum, although in alternative embodiments the light 114 could be, for example, infrared light or ultraviolet light. In some embodiments, as shown in FIG. 9, for example, the light source 110 is a laser diode. The emitted light 114 is thus a laser beam. In other embodiments, as shown in FIGS. 5 and 7, the light source 110 is a light emitting fiber or diode. Still further, any suitable light source 110 is within the scope and spirit of the present disclosure.

In further exemplary embodiments, the emitted light 114 or any portion thereof is a generally collimated beam. Thus, the rays of light 114 in the beam are approximately parallel, thus dispersing relatively minimally over relatively long distances.

As shown and discussed, the light source 110 of a sensor assembly 102 emits a light 114. The sensor assembly 102 further includes a sensor 112. The sensor 102 is configured to sense the light 114. Thus, a sensor 112 according to the present disclosure detects light 114 emitted by the associated light source 110. Further, the sensor 102 is configured to measure a location of the light 114 that is detected by the sensor 102. This measurement may take place in a plane perpendicular to the longitudinal axis 98 of the shaft 40. An x-axis 116 and y-axis 118, both of which are perpendicular to the longitudinal axis 98, define this plane, as shown. By measuring the location of the light 114 in this plane, the sensor 102 may thus provide an indication of movement of the shaft 40 about the longitudinal axis 98 due to bending 92 and/or torsion 94 loads.

For example, the light source 110 and sensor 112 in exemplary embodiments are aligned with respect to the longitudinal axis 98. Thus, light 114 emitted by the light source 110 may travel generally parallel to the longitudinal axis 98. When the shaft 40 is not subjected to bending 92 and/or torsion 94 loads, the light 114 may for example be detected at a predetermined location 120, which may be for example a central location in the plane. Additionally or alternatively, the light 114 may for example be detected at a predetermined level (light energy or intensity), or at predetermined relative levels, throughout the plane. However, when the shaft 40 is subject to bending 92 and/or torsion 94 loads, these loads may move the light source 110 and sensor 112 from their alignment along the longitudinal axis 98. Thus, the light 114 may travel at an angle to the longitudinal axis 98 relative to the bending 92 and/or torsion 94 loads that are occurring. The light 114 may thus be detected at an offset location 122 from the predetermined location 120, or at a different level or levels throughout the plane. The offset and/or difference in level may relate to the bending 92 and/or torsion 94 loads, and allow such loading to be calculated.

In some embodiments, as shown in FIG. 9, the sensor 112 is a complimentary metal-oxide-semiconductor (“CMOS”) array or a charge-coupled device (“CCD”) array. Such sensors 112 generally detect light and convert this detected light to an electronic signal. As shown in FIG. 9, the sensor 112 in these embodiments may further measure the location of the light 114, such as relative to a predetermined location 120, in the plane perpendicular to the longitudinal axis 98.

In other embodiments, as shown in FIGS. 5 and 7, the sensor 112 is a fiber optic sensor. In some embodiments as shown in FIG. 5, for example, one, two, or more rings 124 of sensing fibers 126, which in some embodiments may be coaxial, may be included in the fiber optic sensor. Each ring 124, and the fibers 126 thereof, may collect and thus detect portions of the light 114 at varying levels dependent on the location of the light 114 in the plane. These relative light levels thus relate to the location of the light 114, and further may relate to the bending 92 and/or torsion 94 loads, and allow such loading to be calculated. FIG. 6, for example, illustrates graphical representations of various levels of light 114 detected by a fiber optic sensor having two rings 114 of sensing fibers 126. As shown, when the light 114 level detected by the outer ring 114 increases and the light 114 level detected by the inner ring 114 decreases, the bending 92 and/or torsion 94 loading is increasing, and vice versa.

In other embodiments, as shown in FIG. 7, for example, one, two, or more lines 128 of sensing fibers 128, which in some embodiments are linear, may be included in the fiber optic sensor. For example, two lines 128 are shown, with one line 128 parallel to the x-axis 116 and the other line 128 parallel to the y-axis 118. The various sensing fibers 126 of each line 128 may collect and thus detect portions of the light 114 at varying levels dependent on the location of the light 114 in the plane. These relative light levels thus relate to the location of the light 114, and further may relate to the bending 92 and/or torsion 94 loads, and allow such loading to be calculated. FIG. 6, for example, illustrates graphical representations of various levels of light 114 detected by a fiber optic sensor having a line 128 of fibers 126. As shown, when the light 114 level detected by fibers 126 further from a central point, such as a predetermined location 120, increases, the bending 92 and/or torsion 94 loading is increasing, and vice versa.

It should further be understood that the present disclosure is not limited to the above disclosed sensors, and rather that any suitable light detecting sensor 112 is within the scope and spirit of the present disclosure.

In some embodiments, the sensor 112 may further include a collimating lens (not shown). The collimating lens may improve the signal-to-noise ratio of the sensor, such that the accuracy of the light 114 sensed by the sensor 112 is improved. Further, in some embodiments, the sensor 112 may include a coating layer (not shown), which may for example be transparent, for filtering out undesired ambient light, further increasing the accuracy of the sensor 112. Still further, any suitable filters and/or filtering apparatus, such as suitable narrow band filters, may be included in the sensor 112 to improve the accuracy thereof.

As discussed, the light source 110 and sensor 112 of a sensor assembly 102 are in alignment along the longitudinal axis 98 such that the light 114 is emitted along the longitudinal axis 98. In some embodiments as shown in FIG. 3, for example, the light source 110 and the sensor 112 are spaced apart along the longitudinal axis 98. The light 114 emitted from the light sensor 110 thus travels in a direction along the longitudinal axis 98 to the sensor 112. In other embodiments, as shown in FIG. 4, for example, the sensor 112 may comprise the light source 110, such that the sensor 112 and light source 110 are disposed generally the same location along the longitudinal axis 98. In these embodiments, the sensor assembly 102 may further include, for example, a mirror 130. The mirror 130 may be mounted to the shaft 40 (as discussed above with respect to the light source 110 and sensor 112) and spaced apart from the sensor 112 and thus the light source 110. The light 114 emitted from the light sensor 110 thus travels in a direction along the longitudinal axis 98 to the mirror 130, and then be reflected by the mirror 130 and travel in a reverse direction along the longitudinal axis 98 to the sensor 112.

As further shown in FIGS. 3 and 4, a sensor assembly 102 may further include a sheath 132. The sheath 132 may generally surround the sensor assembly 102, such that the sensor assembly 102 is generally fully encased by the sheath 132 and shaft 40. The sheath 132 may protect the various other elements of the sensor assembly 102 from, for example, dust and dirt, rain, snow, and other potentially damaging materials. A sheath 132 according to the present disclosure may be formed from any suitable material, such as a metal, plastic, or ceramic material. Further, in some embodiments, the sheath 132 is desirably opaque, to thus allow the light 114 to be better sensed by the sensor 112.

As discussed, a sensor assembly 102 according to the present disclosure includes a sensor 112 that senses light 114 and measures the location of the light 114 in a plane perpendicular to the longitudinal axis 98. The location of the light 114 may relate to the bending 92 and/or torsion 94 loading to which the shaft 40 is subjected. Thus, in further exemplary embodiments, a load control system 100 according to the present disclosure may include a controller 140. The controller 140 may be communicatively coupled to the sensor assembly 102 and configured to calculate a moment, such as a bending 92 moment or torsional 94 moment, based on the location of the light 114 in the plane. Such controller 140 thus converts data provided by a sensor 112 into a bending 92 moment or torsional 94 moment. For example, the sensor 112 may provide electrical data or optical light data. This data may be processed to calculate a bending 92 moment or torsional 94 moment, such as by converting the data to a strain measurement which may then be converted to a moment measurement. It should be understood that the controller 140 may have any suitable configuration as discussed above with respect to the controller 26, and in some embodiments may be combined with controller 26.

The controller 140 is communicatively coupled to the sensor assembly 102. In some embodiments, this coupling may be through a slip ring 150, as shown in FIG. 4. The slip ring 150 may be located in and thus a portion of the shaft 40. Further, in some embodiments, the slip ring 150 is an optical slip ring, which may thus transmit light energy therethrough. This light energy may then be converted to electrical signals or supplied directly to the controller 140. In other embodiments, the slip ring 150 is an electrical slip ring, which may thus transmit electrical signals to the controller 140. In still other embodiments, the coupling may be a wireless coupling, as shown in FIG. 3. Electrical signals may thus be transmitted wirelessly from the sensor 102 to the controller 140.

In some embodiments, the controller 140 is additionally or alternatively configured to adjust an operational parameter of the wind turbine 10 based on the location of the light 114 on the sensor 112. Adjustment may be based directly on the location of the light 114, or may be based on the calculated moment as discussed above. Operational parameters include, for example, pitch and/or yaw, as discussed above. Thus, the controller 140 may be in communication with or combined with the controller 26. Such adjustment of the operational parameters may adjust, such as desirably reduce, the loading on the shaft 40. For example, pitch and/or yaw may be adjusted to reduce loading, and in particular bending 92 and/or torsional 94 loading, on the shaft 40, as desired or required during operation of the wind turbine 10.

In some embodiments, the control system 140 may be configured to adjust operational parameters of the wind turbine 10 according to a constant feedback loop or at predetermined increments. Thus, the control system 140 may include suitable software and/or hardware for constantly or incrementally monitoring and calculating moments in real-time, and for adjusting operational parameters as required in order for such moments to be maintained within a predetermined window or above or below a predetermined minimum or maximum amount.

The present disclosure is further directed to methods for controlling wind turbine 10 loading. Such methods may include, for example, emitting a light 114 from a light source 110 mounted to a shaft 40, such as discussed above for example. A method may further include sensing the light 114 at a sensor 112 mounted to the shaft 40, such as discussed above for example. Further, a method may include calculating a shaft moment, such as a bending 92 and/or torsion 94 moment, based on a location on the sensor 112 of the sensed light 114, such as discussed above for example. Still further, in some embodiments, a method may include adjusting an operational parameter of the wind turbine 10, such as pitch and/or yaw, based on the location of the light 114, such as discussed above for example.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A load control system for a wind turbine having a rotor shaft defining a longitudinal axis, comprising:
a sensor assembly, the sensor assembly comprising:
a light source mounted to the rotor shaft and configured to emit a light; and
a sensor mounted to the rotor shaft and configured to sense the light and measure a location of the light in a plane perpendicular to the longitudinal axis; and
a controller communicatively coupled to the sensor assembly.

2. The load control system of claim 1, wherein the sensor is spaced apart from the light source along the longitudinal axis.

3. The load control system of claim 1, wherein the sensor comprises the light source, and further comprising a mirror, the mirror mounted to the rotor shaft and spaced apart from the sensor.

4. The load control system of claim 1, wherein the light source is a laser diode.

5. The load control system of claim 1, wherein the light source is light emitting fiber.

6. The load control system of claim 1, wherein the sensor is a complimentary metal-oxide-semiconductor array.

7. The load control system of claim 1, wherein the sensor is a charge-coupled device array.

8. The load control system of claim 1, wherein the sensor is a fiber optic sensor.

9. The load control system of claim 1, wherein the controller is configured to calculate a rotor shaft moment based on the location of the light.

10. The load control system of claim 1, further comprising an optical slip ring communicatively coupling the sensor assembly and the controller.

11. The load control system of claim 1, further comprising an electrical slip ring communicatively coupling the sensor assembly and the controller.

12. The load control system of claim 1, wherein the controller is configured to adjust an operational parameter of the wind turbine based on the location of the light.

13. The load control system of claim 1, further comprising a sheath generally surrounding the sensor assembly.

14. The load control system of claim 1, wherein the sensor assembly is a plurality of sensor assemblies spaced apart from each other in an annular array about the rotor shaft.

15. A wind turbine, comprising:
a tower;
a nacelle mounted to the tower;
a rotor coupled to the nacelle, the rotor comprising a hub and a plurality of rotor blades;
a generator;
a rotor shaft extending between the rotor and the generator;
a sensor assembly, the sensor assembly comprising:
a light source mounted to the rotor shaft and configured to emit a light; and
a sensor mounted to the rotor shaft and configured to sense the light and measure a location of the light in a plane perpendicular to the longitudinal axis; and
a controller communicatively coupled to the sensor assembly.

16. The wind turbine of claim 15, wherein the controller is configured to calculate a rotor shaft moment based on the location of the light.

17. The wind turbine of claim 15, wherein the controller is configured to adjust an operational parameter of the wind turbine based on the location of the light.

18. The wind turbine of claim 17, wherein the operational parameter is a pitch of one of the plurality of rotor blades.

19. A method for controlling wind turbine loading, the method comprising:
emitting a light from a light source mounted to a rotor shaft;
sensing the light at a sensor mounted to the rotor shaft; and, calculating a rotor shaft moment based on a location on the sensor of the sensed light.

20. The method of claim 19, further comprising adjusting an operational parameter of the wind turbine based on the location of the light.
